(19) United States
(12) Patent Application Publication
(10) Pub. No.: US 2013/0332296 A1
(43) Pub. Date: Dec. 12, 2013

(54) System and Method for Creation and Distribution of Author Signed Electronic Books

(71) Applicant: Samuel John Murray, JR., New Canaan, CT (US)

(72) Inventor: Samuel John Murray, JR., New Canaan, CT (US)

(21) Appl. No.: 13/493,135

(22) Filed: Jun. 11, 2012

(51) Int. Cl. G06Q 30/06

(52) U.S. Cl. 705/26.1

(57) ABSTRACT

A computer-implemented method and data processing system for creating and distributing electronic books employs a database storing information for authenticating author users and customer users. The system interacts with a particular author user via a first networked computer system to generate data representing a handwritten signature of the particular author user. The signature data and associated time stamp data are integrated into an electronic book to produce a signed electronic book associated with the particular author, which is stored in the database along with related ownership information. The system interacts with a particular customer user via operation of a second networked computer system to initiate purchase of a signed electronic book. The ownership information stored in the database is updated to reflect purchase of the signed electronic book by the particular customer user and to enable distribution of the signed electronic book to the particular customer user.

### BACKGROUND

1. Field

The present application relates to the creation and distribution of electronic books.

2. Related Art

Books are popular collector's items. For many reasons, men and women all over the world seek out rare editions of books from authors of varying time periods to add to their personal collections and to secure as investments. Some of the most valuable works are those that are both first edition and signed by the author. The two things that make most literary books valuable are rarity and demand. In the world of book collecting, there is perhaps nothing more valuable than a signed first edition book by a popular author. The first edition status makes the book rare, while the signature makes it even more unique. If one can authenticate the first edition status as well as the signature of a book, the value of the book increases greatly.

Authenticating a signed book is performed by experts that typically use the International Society of Appraisers' standards for authenticating the edition as well as the signature of the signed book.

### SUMMARY

The present application allows for the integration of data representing an author signature and other related data into an electronic book (the resultant electronic book referred to as a signed electronic book or Signed E-book) as well as a distribution of the signed electronic book to customers in a manner that automates the authentication of the signed electronic book.

A computer-implemented method and data processing system is provided for creating and distributing electronic books. The method (and system) employs a database that stores information for authenticating author users and customer users. The system interacts with a particular author user via a first networked computer system to generate data representing a handwritten signature of the particular author user. Time stamp data is automatically generated for the signature data. The signature data and associated time stamp data are integrated into an electronic book to produce a signed electronic book associated with the particular author, which is stored in the database along with related ownership information. The system interacts with a particular customer user via operation of a second networked computer system to initiate purchase of a signed electronic book. The ownership information stored in the database is updated to reflect purchase of the signed electronic book by the particular customer user and to enable distribution of the signed electronic book to the particular customer user.

The method and system of the present application has many advantages, including but not limited to the following:
author uses accounts are established with the author's identity authenticated.
signed electronic books include author signatures that are captured by authenticated author users of the system.
transfers of the signed electronic books are accomplished through the system to allow the system to retain and track all ownership records of the signed electronic books; this allows the system to verify that a buying party receives a signed electronic book that has not been sold previously.

In one embodiment, a registration number, edition number, and/or a digital signature of the author can be integrated into the signed electronic book associated with the particular author. The digital signature, when present, can be used for authenticating the signed electronic book. The edition number can designate the signed electronic book as a limited edition book, which is typically released in a limited print run quantity, usually much smaller than publishing industry standards, and connotes a level of scarcity or exclusivity. The embedded author signature of the limited edition electronic book can make the signed electronic book more exclusive and collectible, and thus increase the value of the signed electronic book.

In another embodiment, a code or watermark or other data unique to the customer user that currently owns a signed electronic book can be integrated into the signed electronic book. Such data can be used by a verification process to verify that a particular customer user that possesses a signed electronic book is in fact the record owner of the possessed signed electronic book.

In still another embodiment, the system can interact with a particular author user via operation of the first networked computer processing system to generate multimedia data, and the system integrates the multimedia data into the signed electronic book.

### BRIEF DESCRIPTION OF THE DRAWINGS

FIG. 1 is a schematic diagram of an electronic commerce system that provides for the creation and distribution of electronic books that embed data representing the handwritten signature of the author of such electronic books as well as other related data.

FIG. 2 is a schematic diagram of the digital data embedded into an electronic book according to the present application.

FIG. 3A is a schematic diagram of a graphical user interface presented on an author computer system 111 for interacting with the system 100 of FIG. 1 to authenticate an author user.

FIG. 3B is a schematic diagram of a graphical user interface presented on an author computer system 111 for interacting with the system 100 of FIG. 1 to upload an e-book from the author computer system 111 to the system 100.

FIG. 3C is a schematic diagram of a graphical user interface presented on an author computer system 111 for interacting with the system 100 of FIG. 1 to allow the author user to specify a number of e-book copies that are to be signed by the author user.

FIG. 3D is a schematic diagram of a graphical user interface presented on an author computer system 111 for capturing a handwritten signature of an author user for communication to the system 100.

FIG. 3E is a schematic diagram of a graphical user interface presented on an author computer system 111 for interacting with the system 100 of FIG. 1 to upload multimedia data from the author computer system 111 to the system 100.

FIG. 3F is a schematic diagram of a graphical user interface presented on an author computer system 111 for interacting with the system 100 of FIG. 1 to allow the author user to review the captured handwritten signature as part of a Signed E-book and accept and/or reject the Signed E-book.

FIG. 4A is a schematic diagram of a graphical user interface presented on a customer computer system 112 or 113 for interacting with the system 100 of FIG. 1 to authenticate a customer user.

FIG. 4B is a schematic diagram of a graphical user interface presented on a customer computer system 112 or 113 for interacting with the system 100 of FIG. 1 to allow the customer user to select a Signed E-book and initiate purchase of the selected Signed E-book.

FIG. 4C is a schematic diagram of a graphical user interface presented on a customer computer system 112 or 113 for interacting with the system 100 of FIG. 1 to allow the customer user to select a Signed E-book owned by the customer user and download of the selected Signed E-book owned by the customer user.

FIG. 4D is a schematic diagram of a graphical user interface presented on a customer computer system 112 or 113 for interacting with the system 100 of FIG. 1 to allow the customer user to select a Signed E-book owned by the customer user and initiate sale of the selected Signed E-book.

### DETAILED DESCRIPTION OF THE PREFERRED EMBODIMENTS

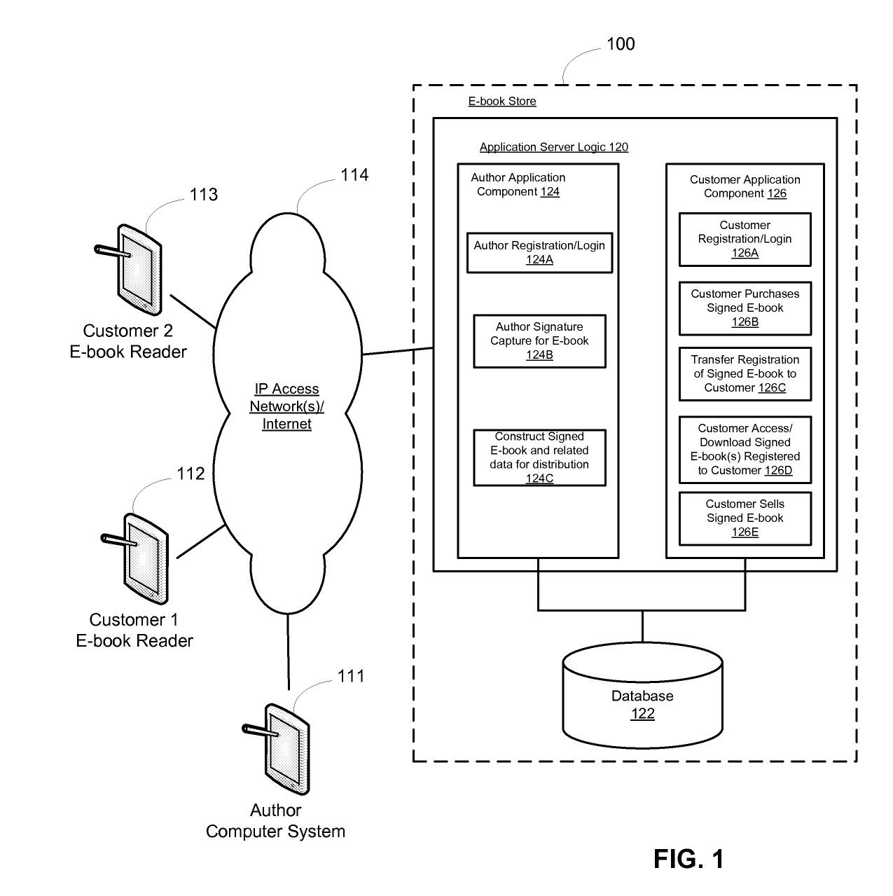

Turning now to FIG. 1, there is shown the architecture of an electronic commerce system 100 that provides for the creation of electronic books that embed data representing the handwritten signature of the author whom has written or complied or edited or otherwise contributed to the respective E-book (referred to herein as a “Signed E-book”). Other multimedia data (such as an audio file that captures an audio message spoken by the respective author or a picture or video of the author captured during the signing of the Signed E-book) can also be embedded into the Signed E-book. The Signed E-book can represent various forms of publications, including (but not limited to) books, magazines, newspapers, newsletters, manuals, guides, references, articles, reports, documents, memorabilia documents (such as magazines, photos, cards, posters, and books), etc. The system 100 also provides for distribution (including sale and re-sale) of the Signed E-books to customers. The system 100 of FIG. 1 operates in a distributed computing environment including several computer systems (such as three labeled 111, 112, and 113) that are interconnected to the system 100 via communication links, e.g., using one or more computer networks such as the IP Access Network and Internet 114 as shown. The system 100 includes application server logic 120 and a back-end database system 122. Each of the application server logic 120 and the database system 122 is described below in more detail. There are generally two classes (denoted “Authors” and “Customers”) of users that access the application server logic 120. An Author user operates an Author computer system 111 to interact with the application server logic 120 over the network 114. The Author computer system 111 can be a PC, workstation or mobile computer system (such as laptop, netbook tablet or netbook). Preferably, the Author computer system 111 includes a touchscreen or other suitable hardware for capturing the handwritten signature of the Author user that operates the system 111. The Customer users operate a Customer computer system (112 or 113) to interact with the application server logic 120. The Customer computer systems 112 or 113 can be an e-book reader device (such as Kindle e-reader from Amazon or a Nook e-reader from Barnes and Noble) or possibly a virtual e-book reader application executing on a PC, workstation or mobile computer system (such as laptop, netbook tablet or netbook).

Preferably, the interaction between the computer systems (e.g., systems 111, 112, 113) and the application server logic 120 occur over TCP/IP sessions established therebetween over which are communicated HTML-based (and possibly XML-based) documents and commands as well as other messages, commands and data. The application server logic 120 enables login and authentication of an Author user via interaction with the Author system 111. The application server logic 120 enables login and authentication of a Customer user via interaction with the Customer system (112 or 113). Such login and authentication can utilize password-based authentication, operating system-based authentication (e.g., NTLM or Kerberos); services-based authentication (e.g., Microsoft Passport authentication), certificate-based authentication, or any other authentication scheme. Once a user session has been authorized (whether it be an Author session or Customer session), the application server logic 120 generates dynamic HTML-based (and possibly XML-based) documents and commands and serves the dynamic documents to the Author system 111 (or the Customer system 112 or 113) as needed. The application server logic 120 may be based upon commercially available application servers, such as the WebLogic Application Server from Oracle, the WebSphere Application Server from IBM, and JBoss AS from JBoss (a division of Red Hat).

In brief, the application server logic 120 includes an author application component 124 that is generally responsible for interacting with an authenticated Author user to create one or more Signed E-books that embed data representing the handwritten signature of the author whom has written or complied or edited or otherwise contributed to the respective E-book. Other multimedia data (such as an audio file that captures an audio message spoken by the respective author or a picture or video of the author captured during the signing of the Signed E-book) and other data (e.g., a time stamp, trusted time stamp, digital signature, etc.) can also be embedded into the Signed E-books. The Signed E-book is configured in a suitable format. For example, the widely supported EPUB format can be used. The EPUB format is a vendor-independent XML-based e-book format. Other e-book formats can also be used. The Signed E-book is stored in the database system 122 along with registration information for each Signed E-book. The registration information associated with a respective Signed E-book identifies the current registered owner of the respective Signed E-book. Initially, the registration information associated with a respective Signed E-book identifies the author of the respective Signed E-book as the current owner of the respective Signed E-book.

The application server logic 120 also includes a customer application component 126 that is generally responsible for interacting with an authenticated Customer user to initiate purchase of at least one Signed E-book stored in the database system 122. The customer application component 126 also updates the registration information for purchased Signed E-book(s) as stored in the database system 122 to identify the authenticated Customer user that purchased the Signed E-book(s) as the current registered owner. In this manner, the first purchase of the respective Signed E-book updates the registration information to transfer ownership from the Author to the authenticated Customer user that purchased the respective Signed E-book. Subsequent purchases of the respective Signed E-book updates the registration information to transfer ownership from the previous Customer user to the Customer user that last purchased the respective Signed E-book. The customer application component 126 also controls Customer user access to Signed E-books stored in the database system 122. Specifically, the customer application component 126 allows a respective authenticated Customer user to access (for example, by download operations to an e-book reader or the like) only those Signed E-book(s) for which the respective authenticated Customer User is the registered owner.

In a preferred embodiment, the author application component 124 includes author registration and login logic 124A that interacts with an Author user via operation of the Author system 111 to enable registration of the Author user. Such registration can involve creating an account for the Author user, assigning a name or other identifier for the Author user that uniquely identifies the Author user from other users, assigning a password for the Author user for authentication purposes, and possibly generating other authentication data (such as credit card information for the Author user and/or biometrics of the Author user) that can be used to authenticate the Author user. During the registration process, the Author system 111 is preferably controlled to present the Author user with a graphical user interface where the Author user consents to requirements for the account. Such requirements can include a requirement that account access is intended to be limited to the Author user alone as well as a requirement that all signatures attributable to the Author User will be provided by the Author user. The Author information generated during such registration is stored in the database system 122 for subsequent access.

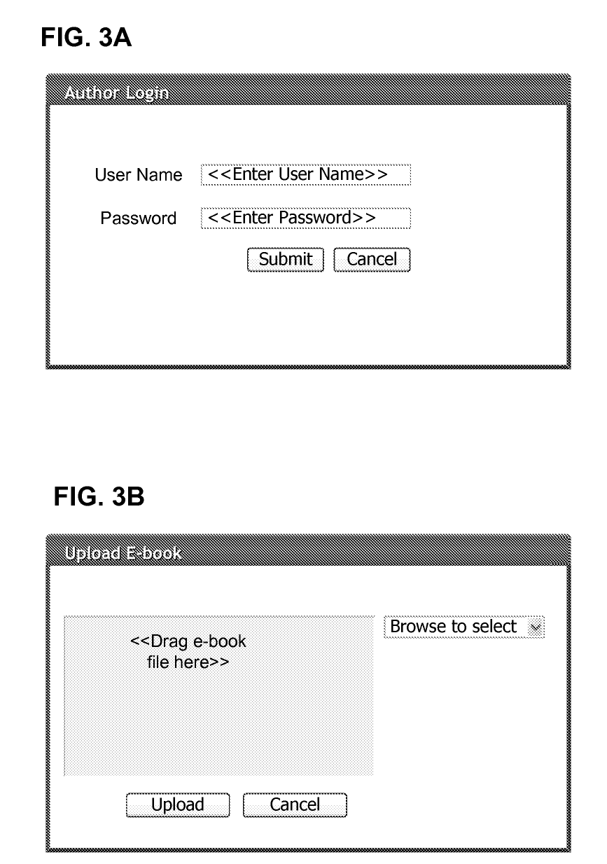

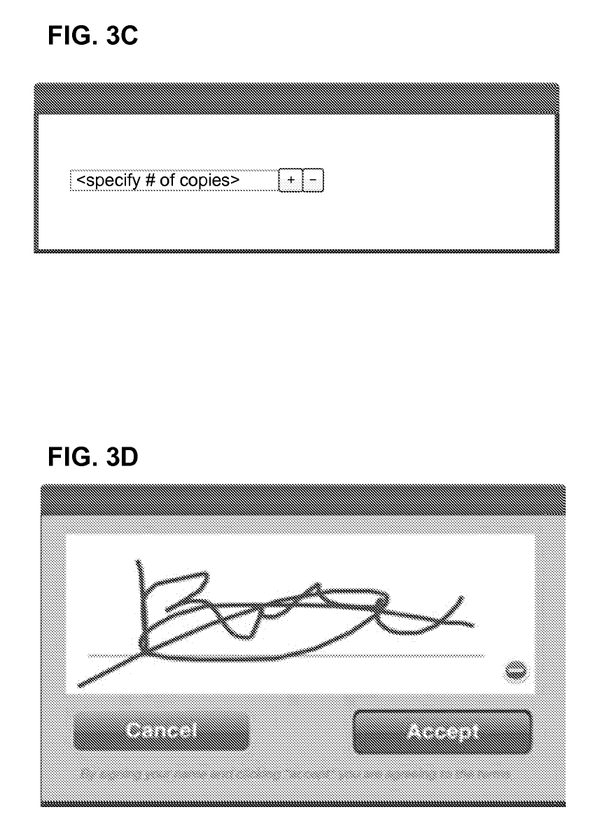

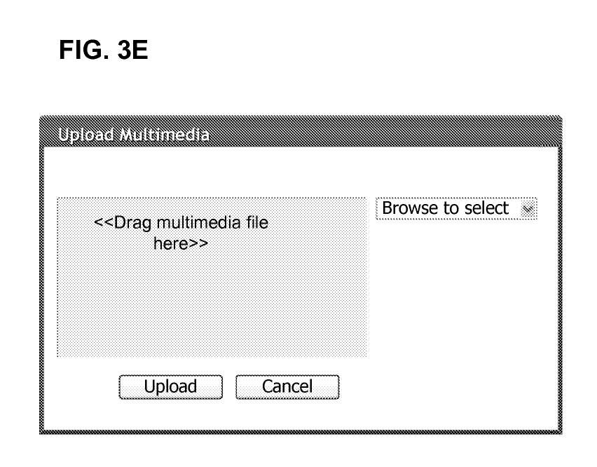

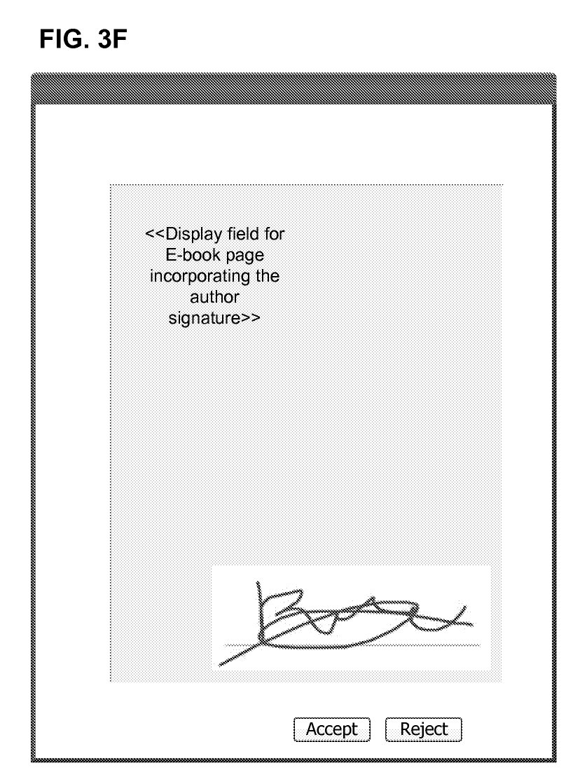

The author registration and login logic 124A also preferably interacts with an Author user via operation of the Author system 111 to enable login and authentication of the Author user after registration is completed. Such login and authentication can involve the Author user inputting via keyboard input (or possibly by some other form of user input such as speech-to-text input) the user name and password assigned to the Author user as shown in the exemplary interface of FIG. 3A. The logic 124A determines whether the entered user name and password matches an Author user name and password stored in the database 122. If so, the authentication of the Author user is successful. Otherwise, the authentication fails and the logic 124A and Author system 111 cooperate to communicate the login error to the user and possibly repeat the login process. It is possible that other factors can be integrated into the authentication process. For example, security questions and biometrics such as a voiceprint, fingerprint, facial scan, etc. can be integrated into the authentication process.

In the preferred embodiment, the author application component 124 also includes author signature capture logic 124B that interacts with an authenticated Author user via operation of the Author system 111 to upload an e-book which is written or complied or edited or otherwise attributed to the authenticated Author user. The uploaded e-book can be stored in the database system 122. An example of an interface presented on the Author system 111 for such upload is shown in FIG. 3B. The logic 124B also interacts with the authenticated Author user via operation of the Author system 111 to specify a number of copies of the uploaded e-book that will be signed by the authenticated Author user for distribution to customers. An example of an interface presented on the Author system 111 for specifying the number of copies of the uploaded e-book that will be signed by the authenticated Author user is shown in FIG. 3C.

For each one of the specified number of copies, the logic 124B controls the Author system 111 to present the authenticated Author user with a graphical user interface that allows for the authenticated Author user to capture data representing the handwritten signature of the authenticated Author user. Such data can be an image file of the handwritten signature of the authenticated Author user or possibly other suitable data. The Author system 111 can include a touch screen that allows for the capture of the Author's handwritten signature on the touch screen with a stylet or the like. Alternatively, the Author system 111 can include a signature capture pad or other suitable form of signature capture. In another alternative, the signature data can be generated by other means (such as by selecting the signature data from electronic storage such as hard disk, USB drive, network storage, or cloud storage). An example of an interface presented on the Author system 111 for capturing data representing the handwritten signature of the authenticated Author user is shown in FIG. 3D. The captured data representing the handwritten signature of the authenticated Author user is communicated to the logic 124B, which can store such data in the database system 124 in association with the uploaded e-book of the Author user. The logic 124B automatically embeds the data representing the handwritten signature of the Author user into the respective copy of the uploaded e-book. The placement of the handwritten signature of the author-user in the uploaded e-book copy can be dictated by user input of the Author user or can be automatic in nature (such as automatically placing the signature on the title page of the uploaded e-book copy). In this case, the data representing the handwritten signature of the Author user is added to the package of the uploaded e-book copy. One or more elements of the package (e.g., the manifest element, spine element and/or guide element for the EPUB format) can be updated to reflect the addition of the author signature data.

The logic 124B can also interact with the authenticated Author user via operation of the Author system 111 to capture and embed multimedia data (such as audio data, image data or video data associated with the signing process) into the uploaded e-book copy. For example, the Author system 111 can include (or interface) to a still image or video camera that captures image data and/or video data associated with the signing process. Alternatively, the multimedia data can be generated by other means (such as by selecting the multimedia data from electronic storage such as hard disk, USB drive, network storage, or cloud storage). Such image data and/or video data can be uploaded to the logic 124B, which integrates such image data and/or video data together with the embedded signature data into the uploaded e-book copy. An example of an interface presented on the Author system 111 for the upload of such multimedia data is shown in FIG. 3E. The placement of such multimedia data in the uploaded e-book copy can be dictated by user input of the Author user or can be automatic in nature (such as automatically placing such data after the title page of the uploaded e-book copy). In this case, such image data and/or video data are added to the package of the uploaded e-book copy. One or more elements of the package (e.g., the manifest element, spine element and/or guide element for the EPUB format) can be updated to reflect the addition of the author signature data.

The logic 124B can also control the Author system 111 to present the authenticated Author user with a graphical user interface that allows for the authenticated Author user to review the uploaded e-book copy with embedded signature data (and possible multimedia data). The graphical user interface can also allow the authenticated Author user to delete and recapture the Author user's signature or other multimedia data (or possibly move such data) if desired. An example of an interface presented on the Author system 111 for such review is shown in FIG. 3F. When the Author user is satisfied, the Author user submits the e-book copy with embedded signature (and possible multimedia data), for example, by clicking on a submit button of FIG. 3F or the like), which triggers the logic 124B to add a time stamp representing the date and time of origination of the author signature to the e-book copy with embedded signature (and possible multimedia data) and to save the resultant e-book copy (referred to herein as “Signed E-book”) in the database system 122. As part of the signing process, the logic 124B can control the Author system 111 to present the authenticated Author user with a graphical user interface where the Author user confirms that the signature was in fact written by the authenticated Author user.

The logic 124B can also possibly assign a registration number and edition number to the Signed E-book. The registration number can be unique to the given Signed E-book (i.e., it can uniquely identify the given Signed E-book from other Signed E-books distributed by the system 100). The registration number (possibly in coded form) and the edition number can be embedded into the Signed-Book. The edition number can designate the Signed E-book as a limited edition book, which is typically released in a limited print run quantity, usually much smaller than publishing industry standards, and connotes a level of scarcity or exclusivity. The embedded author signature of the limited edition Signed E-book can make the Signed E-book more exclusive and collectible, and thus increase the value of the Signed E-book.

The logic 124B can also possibly embed a trusted timestamp and/or a digital signature for the authenticated Author user into the Signed E-book. The trusted timestamp is issued by a trusted third party acting as a time stamping authority. The digital signature for the authenticated Author user can be part of a three part signing scheme. The first part uses a key generation algorithm to randomly select a private key for the authenticated Author user from a set of possible private keys. The algorithm outputs the private key and a corresponding public key for the authenticated Author user. The second part uses a signing algorithm that, given the Signed E-book and the private key of the authenticated Author user of the Signed E-book, produces a signature. The signature is embedded into the Signed E-book. The third part uses a signature verifying algorithm that, given the Signed E-book (including the embedded signature) and the public key of the authenticated Author, either accepts or rejects the authenticity of the Signed E-book. The digital signature for the authenticated Author User can also be in the form of a code or watermark that is specific to the Author user.

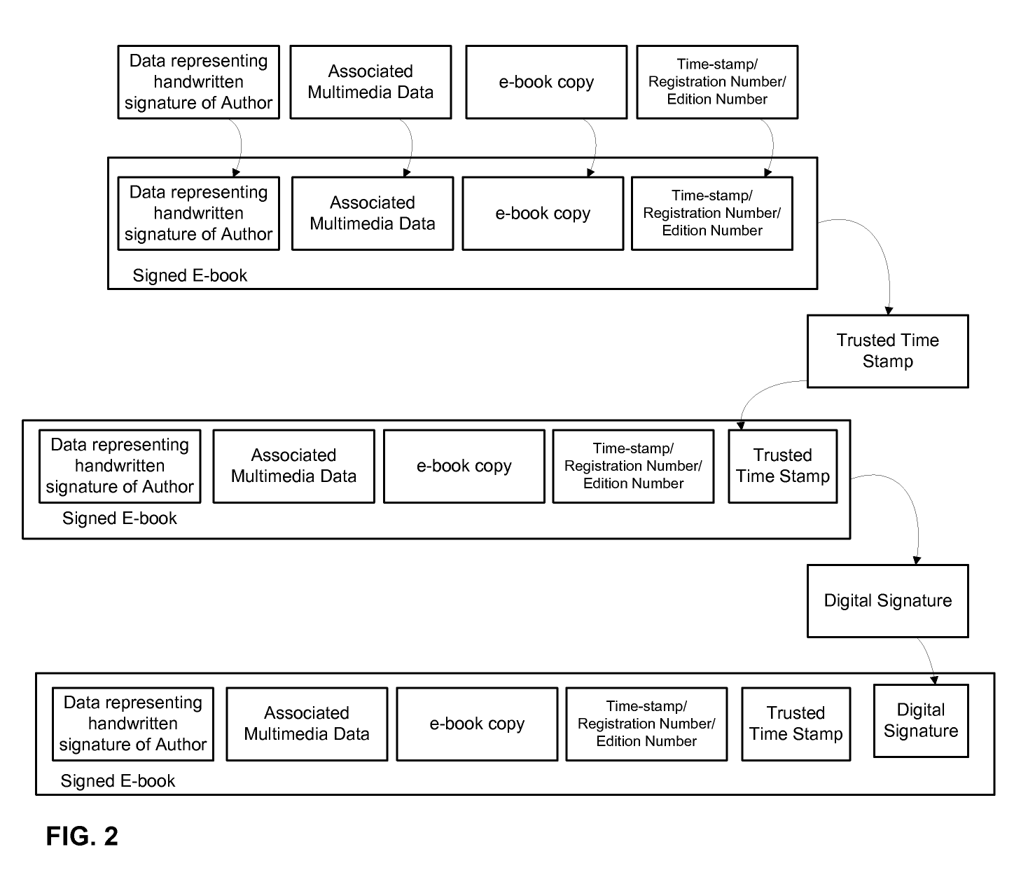

FIG. 2 is a schematic diagram showing the digital data that can be embedded into the Signed E-book by logic 124B. The logic 124B can also possibly embed DRM protection into the Signed E-book. For example, such DRM protection can enable access to the Signed E-book by a limited number of devices associated with the current owner of the Signed E-book.

The logic 124B saves the Signed E-book along with the associated data (such as the registration number, time stamp, trusted time stamp, digital signature) in the database system 122 in association with the account of the authorized Author user.

In a preferred embodiment, the customer application component 126 includes customer registration and login logic 126A that interacts with a Customer user via operation of the Customer system 112 or 113 to enable registration of the Customer user. Such registration can involve creating an account for the Customer user, assigning a name or other identifier for the Customer user that uniquely identifies the Customer user from other users, assigning a password for the Customer user for authentication purposes, and possibly generating other authentication data (such as credit card information for the Customer user and/or biometrics of the Author user) that can be used to authenticate the Customer user. The Customer information generated during such registration is stored in the database system 122 for subsequent access.

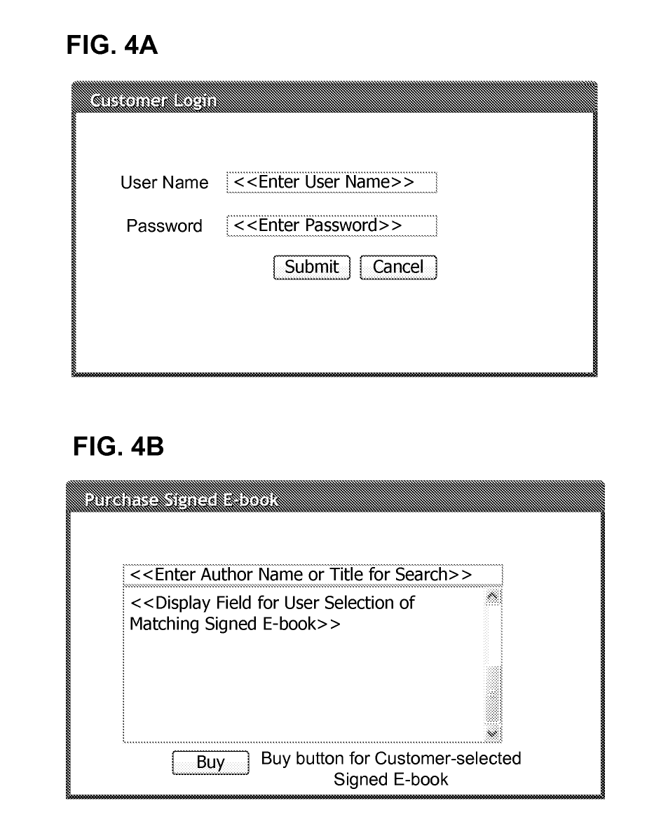

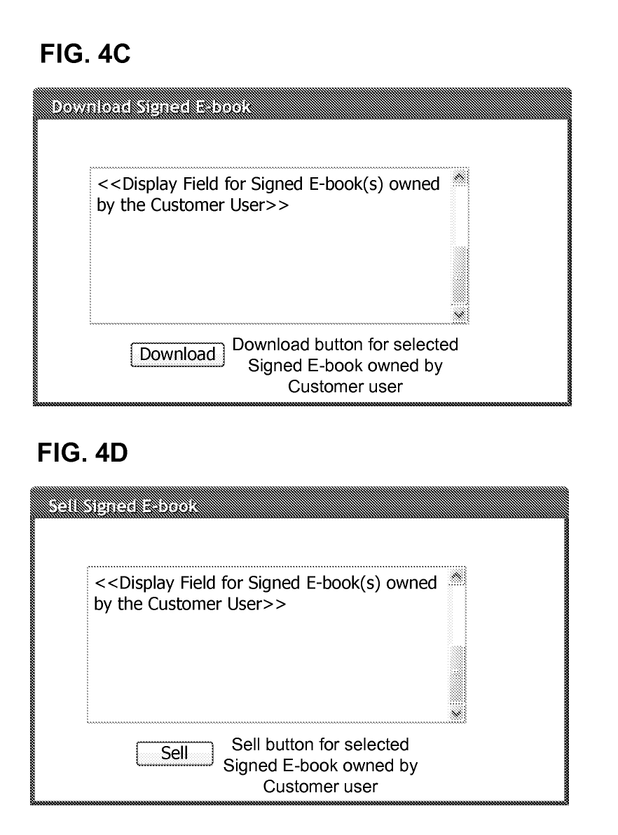

The Customer registration and login logic 126A also preferably interacts with a Customer user via operation of the Customer system 112 or 113 to enable login and authentication of the Customer user after registration is completed. Such login and authentication can involve the Customer user inputting via keyboard input (or possibly by some other form of user input such as speech-to-text input) the user name and password assigned to the Customer user as shown in the exemplary interface of FIG. 4A. The logic 126A determines whether the entered user name and password matches a Customer user name and password stored in the database 122. If so, the authentication of the Customer user is successful. Otherwise, the authentication fails and the logic 126A and Customer system 112 or 113 cooperate to communicate the login error to the user and possibly repeat the login process. It is possible that other factors can be integrated into the authentication process. For example, security questions and biometrics such as a voiceprint, fingerprint, facial scan, etc. can be integrated into the authentication process.

In the preferred embodiment, the customer application component 126 also includes E-book purchase logic 126B that interacts with an authenticated Customer user via operation of the Customer system 112 or 113 to initiate purchase a Signed E-book stored in the database system 122. The logic 126B can allow the authenticated Customer user to browse through the Signed E-books stored in the database system 122, search the Signed E-books stored in the database system 122 or utilize other mechanisms to locate a Sign E-book for purchase by the authenticated Customer user. An example of an interface presented on the Customer system 112 or 113 that allows a Customer user to select a Sign E-book and initiate purchase of the selected Signed E-book is shown in FIG. 4B. The logic 126B can enable the authenticated Customer user to pay for purchased Signed E-book and transfer monies to the seller of the Signed E-book (either the Author for the first sale or possibly a registered Customer for a subsequent sale). Alternatively, the logic 126B can link to suitable payment processing logic such as Amazon payments or Paypal for this purpose. In yet another alternative, payment between the parties can be carried out outside the system 100 and communicated by the users via interaction with the system 100.

Once payment is complete, logic 126C of the customer application component 126 updates the database system 122 to associate the purchased Signed E-book to the account of the particular Customer user who purchased the Signed E-book (thus identifying the particular Customer user as the current owner of the purchased Signed E-book) and grants this particular Customer user access to download the purchased Signed E-book from the system 100. In the case that the Signed E-books employ DRM protection, the DRM protection operates to enable access to the Signed E-book by a limited number of devices associated with the particular Customer user that purchased the Signed E-book.

Logic 126C can also update the database system 122 to transfer the Signed E-book along with the associated data (such as the registration number, time stamp, trusted time stamp, digital signature) such that this information is associated with the account of the particular Customer user that purchased the Signed E-book. Logic 126C can also embed into the Signed E-book a code or watermark or other data that is unique to the particular Customer user that purchased the Signed E-book. Such data can be used for verification of the record owner of the Signed E-book as discussed below.

Logic 126D of the customer application component 126 interacts with an authenticated Customer user via operation of the Customer system 112 or 113 to present the authenticated Customer user with a graphical user interface that allows the authenticated Customer user to download the one or more Signed E-books that are stored in the database system 122 with permissions that allow for download by the authenticated Customer user (i.e., because the Signed E-book(s) is currently owned by the authenticated Customer user). The download can be selectively enabled to one or more devices authenticated Customer user. An example of an interface presented on the Customer system 112 or 113 that allows a Customer user to select a Sign E-book and download the selected Signed E-book is shown in FIG. 4C.

In one embodiment, the database 122 maintains a copy of the Signed E-book. This copy can be accessed (i.e., downloaded) by the Customer user that owns the Signed E-book in the event that the downloaded copy(ies) of the Signed E-book is(are) lost or become corrupted. It is also contemplated that the customer application component 126 can support a verification process that allows for upload of a Signed E-book that is believed to be owned by a respective Customer User. As part of this verification process, the customer application component 126 extracts relevant data embedded in the uploaded Signed E-book (for example, the registration number, time stamp, trusted time stamp, digital signature, owner code or watermark) and compares such data to that of the copy stored in database 122 to verify the authenticity of the Signed E-book. In the manner, the verification process enables the respective Customer User to verify that the Signed E-book in his/her possession is authentic and owned by the respective Customer User (in other words, the respective Customer User is the record owner of the Signed E-book).

Logic 126E of the customer application component 126 interacts with an authenticated Customer user via operation of the Customer system 112 or 113 to present the authenticated Customer user with a graphical user interface that allows the authenticated Customer user to initiate sale of one or Signed E-books that are stored in the database system 122 and currently owned by the authenticated Customer user. An example of an interface presented on the Customer system 112 or 113 that allows a Customer user to select a Sign E-book and initiate sale of the selected Signed E-book is shown in FIG. 4D. The Signed E-book that is being placed on sale can be uploaded and stored in the database system 122, if need be. The registration number, the edition number, the time stamp and possibly additional information (such as a trusted time stamp and digital signature) can be recovered from the Signed E-book and checked against the corresponding information stored in the database 122. Such information should match with the information associated with the Signed E-book and stored in the database 122 in association with the account of the Customer user that owns the Signed E-book. Logic 126E also checks whether the Signed E-book has been sold previously by another user. If all of these criterions are satisfied, the Signed E-book is accepted for sale; otherwise, the Signed E-book is rejected for sale. In the case that the Signed E-book employs DRM protection, the DRM functionality of the system 100 can be adapted to disable access to the Signed E-book by the selling Customer user upon purchase of the Signed E-book by another Customer user (or possibly at some other time). Furthermore, upon purchase of the Signed E-book by another Customer user, the database 122 can be updated to disassociate the Signed E-book from the account of the selling Customer user. Such processing can repeat for follow on sales of the Signed E-book where another Customer user purchases the Signed E-book.

It is also contemplated that the system and methodology as described herein can be adapted such that an Author user can embed a handwritten signature and possibly other suitable media into a Signed E-book for sale to a particular Customer user. For example, the system and methodology can be part of an autographing session where the Author user embeds a handwritten signature and possibly other suitable media into a Signed E-book in the presence of a particular Customer user for sale of the Signed E-book to the particular Customer user. The handwritten signature and media can be personalized for the particular Customer user and subsequently embedded into the Signed E-book for sale to the particular Customer user.

The electronic system of the present application has many advantages, including but not limited to the following:
Author uses accounts are established with the author's identity authenticated.
Signed E-books include author signatures that are captured by authenticated Author users of the system; it does not allow for e-books that might be signed in an offline manner.
All transfers of the Signed E-books are accomplished through the system to allow the system to retain and track all ownership records of the Signed E-books; this allows the system to verify that a buying party receives a Signed E-book that has not been sold previously.

There have been described and illustrated herein several embodiments of a system and method of electronic commerce for creating and distributing electronic documents that embed data representing a handwritten signature of the author as well as other related data. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as claimed.

What is claimed is:

1. A computer-implemented method executed on a data processing system, the method for creating and distributing an electronic book, the method comprising:
i) maintaining a database that stores information for authenticating author users and customer users;
ii) interacting with a particular author user via operation of a first networked computer processing system to authenticate the particular author user based on the information stored in the database and to generate data representing a handwritten signature of the particular author user;
iii) automatically generating time stamp data for the signature data generated in ii);
iv) integrating the signature data generated in ii) and the time stamp data of iii) into an electronic book associated with the particular author user to produce a signed electronic book associated with the particular author;
v) storing in the database the signed electronic book of iv) as well as related ownership information;
vi) interacting with a particular customer user via operation of a second networked computer processing system to authenticate the particular customer user based on the information stored in the database and to initiate purchase of the signed electronic book stored in v);
vii) updating the ownership information stored in the database to reflect purchase of the signed electronic book by the particular customer user; and
viii) enabling distribution of the signed electronic book stored in v) to the particular customer user subsequent to the purchase of the signed electronic book by the particular customer user.

2. A method according to claim 1, further comprising:
integrating a digital signature into the signed electronic book associated with the particular author, the digital signature for authenticating the signed electronic book.

3. A method according to claim 1, further comprising:
interacting with the particular author user via operation of the first networked computer processing system to generate multimedia data;
integrating the multimedia data into the signed electronic book.

4. A method according to claim 1, wherein:
the information for authenticating a respective author user includes a user name and password assigned to the respective author user; and
the information for authenticating a respective customer user includes a user name and password assigned to the respective customer user.

5. A method according to claim 1, further comprising:
assigning a registration number and edition number to the signed electronic book, wherein the edition number can designate the signed electronic book as a limited edition book; and
integrating the assigned registration number and edition number into the signed electronic book.

6. A method according to claim 5, wherein:
the registration number assigned to the signed electronic book is unique to the signed electronic book.

7. A method according to claim 5, wherein:
a coded form of the registration number assigned to the signed electronic is integrated into the signed electronic book.

8. A method according to claim 1, wherein:
the signed electronic book employs a digital rights management protection scheme that controls access to the signed electronic book.

9. A data processing system for creating and distributing an electronic book, the system comprising:
a database that stores information for authenticating author users and customer users;
first logic that interacts with a particular author user via operation of a first networked computer processing system to authenticate the particular author user based on the information stored in the database and to generate data representing a handwritten signature of the particular author user;
second logic that automatically generates time stamp data for the signature data generated by the first logic;
third logic that integrates the signature data generated by the first logic and the time stamp data generated by the second logic into an electronic book associated with the particular author user to produce a signed electronic book associated with the particular author and that stores the signed electronic book as well as related ownership information in the database;
fourth logic that interacts with a particular customer user via operation of a second networked computer processing system to authenticate the particular customer user based on the information stored in the database and to initiate purchase of the signed electronic book stored in the database;
fifth logic that updates the ownership information stored in the database to reflect purchase of the signed electronic book by the particular customer; and
sixth logic that enables distribution of the signed electronic book stored in the database to the particular customer user subsequent to the purchase of the signed electronic book by the particular customer user.

10. A data processing system according to claim 9, further comprising:
logic that integrates a digital signature into the signed electronic book associated with the particular author, the digital signature for authenticating the signed electronic book.

11. A data processing system according to claim 9, further comprising:
logic that interacts with the particular author user via operation of the first networked computer processing system to generate multimedia data; and
logic that integrates the multimedia data into the signed electronic book stored in the database.

12. A data processing system according to claim 9, wherein:
the information for authenticating a respective author user includes a user name and password assigned to the respective author user; and
the information for authenticating a respective customer user includes a user name and password assigned to the respective customer user.

13. A data processing system according to claim 9, further comprising:
logic that assigns a registration number and edition number to the signed electronic book; and
logic that integrates the assigned registration number and edition number into the signed electronic book stored in the database.

14. A data processing system according to claim 13, wherein:
the registration number assigned to the signed electronic book is unique to the signed electronic book.

15. A data processing system according to claim 13, wherein:
a coded form of the registration number assigned to the signed electronic is integrated into the signed electronic book.

16. A data processing system according to claim 9, wherein:
the signed electronic book employs a digital rights management protection scheme that controls access to the signed electronic book.
